(19) United States
(12) Patent Application Publication
(10) Pub. No.: US 2011/0225760 A1
(43) Pub. Date: Sep. 22, 2011

(54) BRICKLAYER'S TROWEL

(76) Inventor: David Garnet Denman, Ashford (GB)

(21) Appl. No.: 12/727,696

(22) Filed: Mar. 19, 2010

(51) Int. Cl. B05C 17/10

(52) U.S. Cl. 15/235.4

(57) ABSTRACT

A novel trowel for use by bricklayers comprised of a flat blade having a first face and an opposing second face and containing at least one protrusion on one face.

### FIELD OF THE INVENTION

The present invention relates to a novel trowel for use by bricklayers. The trowel comprises a flat blade having a first face and an opposing second face and containing at least one protrusion on one face.

### BACKGROUND OF THE INVENTION

Bricklayer's trowels are used in the building trade for applying and spreading mortar. Such trowels are employed to apply and spread mortar on horizontal layers or courses of bricks before the bricks of the next higher course are laid. The thickness of mortar between courses is regulated by horizontal cords and/or by the skill and experience of the bricklayer. Bricklayers sometimes use trowels for cutting or chopping bricks.

A problem encountered in bricklaying is that there is no straightforward means or method of regulating the amount of mortar in the gap or cross joint between the adjacent vertical faces of adjacent bricks in the same course. As a result, a course of bricks could be longer or shorter than the desired length. The present invention is intended to address this problem.

The present invention provides a bricklayer's trowel having the features recited in claim 1 of the set of claims following this description. Optional and/or preferred features of the trowel are the subject of other claims in the said set of claims.

### SUMMARY OF THE INVENTION

In accordance with the present invention there is provided a trowel comprised of a substantially flat quadrilateral blade having four corners and having a first face and an opposing second face and having a handle at one corner, the blade having at least one protrusion on one face of the blade in the region of another corner of the blade.

In a preferred embodiment the trowel also contains a handle at one of its corners.

In another preferred embodiment each protrusion is a substantially smoothly curved surface.

### BRIEF DESCRIPTION OF THE FIGURES

FIG. 1 hereof is a plan view of part of a trowel of the invention.

FIG. 2 hereof is side elevation of the trowel of FIG. 1.

FIG. 3 is a plan view of another trowel according to the invention.

FIG. 4 hereof is a plan view of another trowel according to the invention.

FIG. 5 hereof is a a perspective view of the trowel of FIG. 4 hereof

### DETAILED DESCRIPTION OF THE INVENTION

The present invention provides a novel bricklayer's trowel capable of better regulation of the gap or cross joint between adjacent vertical faces of adjacent bricks in the same course of bricks. The result being that the resulting course of bricks will be of the desired length compared with use of conventional trowels.

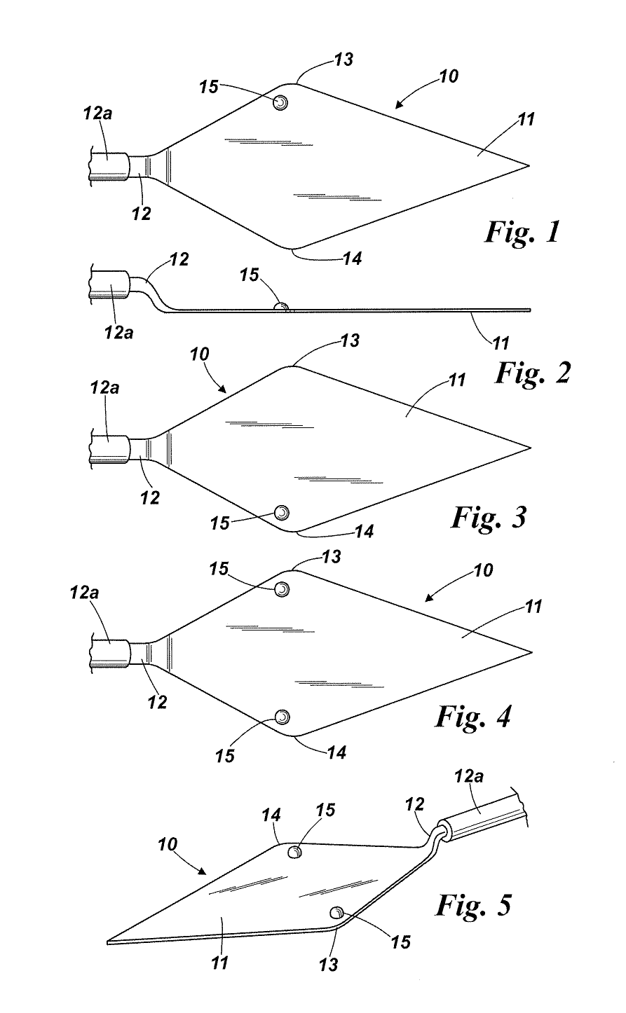

Turning now to the figures hereof, the trowel 10 of FIGS. 1 and 2 comprises a flat quadrilateral blade 11 having four corners (or “shoulders”) and a shaft, ferrule or tube 12 for receiving a handle 12a. The blade 11 preferably has two corners or shoulders 13, 14 adjacent to the end where handle 12a is located. Adjacent to one corner 13, there is provided, or formed, a protrusion 15 which projects from the flat (main or top) surface of blade 11. Protrusion 15 is preferably in the vicinity of corner 13 (e.g., 5 to 12 mm from the corner, preferably 10 mm or thereabouts for a blade having an overall length of about 20 to 30 cm and a width of about 70 mm to about 110 mm) and preferably on or near to the edge of blade 11 between handle 12a and corner 13.

The protrusion 15 may be on a notional line (not shown) joining corners 13 and 14. In some preferred embodiments, protrusion 15 is at a location on blade 11 that is slightly displaced from this notional line so as to be closer to handle 12a. This displacement leaves the adjacent corner 13 substantially unaffected by the presence of protrusion 15 so that it can be employed for cutting bricks in the well-known manner.

Protrusion 15 may be an integral or unitary part of the blade or it may be a separate part which is secured to blade 11 by any suitable means. Thus, protrusion 15 may be a dimple which is integral with blade 11 and formed by pressing or stamping. Alternatively, protrusion 15 may be a separate member secured to the blade, e.g., by spot welding. A suitable separate member (not shown) might be, e.g., a piece of metal resembling the domed head of a dome-headed bolt.

Protrusion 15 is preferably of a substantially smoothly-curved dome-like form and may will preferably have a substantially circular base, as depicted in the figures hereof, since this will be easier to clean than a protrusion having sharp angles. A smoothly-curved domed protrusion can be made by stamping or pressing blade 11. Alternatively, the blade may be formed from suitable sheet metal having a ridged section at or adjacent to the edge of blade 11 which is subjected to a grinding process to form a desired protrusion 15. Another form (not shown) of the protrusion is cylindrical with a flat outer face. This latter form can be made by welding or spot-welding a cylindrical disc (e.g., a stud or boss) to the face of the blade.

Although the present invention is not limited to exact dimensions of instant trowel there are preferred dimensions. For example, it is preferred that the total distance between the free end of the protrusion and the lower or bottom face (as shown) of blade 11 be equal to (or approximately equal to) the desired gap for mortar between adjacent vertical faces of adjacent bricks in the same course. In UK, this distance is typically 10 mm. In USA, this distance is ¼ inch (6.35 cm). Thus for UK use, blade 11 will preferably have a thickness of about 2 mm, protrusion 15 should preferably extend about 8 mm from the surface of the blade 11 from which it protrudes. However, blade 11 may have a thickness in the range of about 1 to 3 mm, and protrusion 15 would then extend a distance in the range of about 9 to 7 mm so that the total thickness of the blade and protrusion will preferably be about 10 mm if the desired gap between adjacent bricks in the same course is about 10 mm.

In use, trowel 10 is employed to apply and spread mortar on bricks. When bricks are being laid, bricks are laid in a bed of mortar to form a horizontal course. As each additional brick is added to the course, mortar is applied by the trowel to the vertical face of the last-laid brick of the course. The corner region 13 of trowel 10 of the present invention is located in the vertical gap between adjacent bricks where it serves as a gauge or spacer, wherein one brick abuts a face of the trowel's blade and the adjacent brick abuts the “top” or free, distal, end of protrusion remote from the main face of blade 11. Thus, the gap or space between adjacent bricks in a course is relatively accurately defined. When adjacent bricks in a course are thus disposed with a gap of the desired size between them, corner region 13 of the trowel is withdrawn from the gap and the gap is filled with mortar to complete the joint. The gaps between bricks in each course can therefore be of substantially uniform dimensions, substantially equal to the thickness of the blade plus the “height” of the protrusion. As a result, each course laid by the method described has substantially the desired length. It has not previously been possible to ensure readily that the gaps or cross-joints between bricks in a course were uniform by use of conventional trowels. The trowel of the present invention enables this difficulty to be surmounted.

The trowel of FIG. 1 hereof is shown with protrusion 15 near one corner or shoulder 13 of blade 11. FIG. 3 hereof shows a trowel of the present invention in which protrusion 15 is near the opposite corner or shoulder 14. All the matters mentioned regarding protrusions 15 of FIG. 1 hereof apply equally to the protrusions 15 of FIG. 3 hereof. The side elevation of the trowel of FIG. 3 is the same as shown in FIG. 2 hereof. The trowel of FIG. 3 hereof could be suited to a left-handed bricklayer, and the trowel of FIG. 1 hereof could be suited to a right-handed bricklayer.

FIG. 4 hereof shows a trowel having two protrusions 15, one near one corner 13 and the other near opposite corner 14. The trowel of FIG. 4 hereof could be suited to bricklayers who are either right handed or left handed. The side elevation of the trowel of FIG. 4 hereof is the same as FIG. 2 hereof. All the matters mentioned regarding the protrusions 15 of FIGS. 1 and 3 apply equally to the protrusions 15 of FIG. 4 hereof. The trowels of FIGS. 3, 4 and 5 are used to set the gap between adjacent bricks in a horizontal course in the same way as the trowel of FIG. 1 hereof.

At least one protrusion 15, preferably all, are preferably located on blade 11 slightly offset from its respective corner(s) 13 or 14 in a direction towards handle 12a, so that the corner(s) 13, 14 can be used for cutting bricks in the well-known manner. The offset distance from the respective comer(s) will preferably be in the range of about 2 to about 20 mm, e.g. about 3 to about 15 mm, for example about 4 to about 12 mm, suitably about 5 to about 10 mm, so that the corner(s) 13, 14 are available for cutting bricks despite the provision of the protrusion(s) 15.

Features of one embodiment described herein may be employed in any feasible combination with features of another embodiment.

What is claimed is:

1. A trowel comprising a substantially flat quadrilateral blade with two opposing faces and having four corners and adapted to have a handle at one corner, the blade having at least one protrusion on one face of the blade at, or in the region of, another corner of the blade.

2. The trowel of claim 1 wherein the said another corner is adjacent to the said one corner.

3. The trowel of claim 1 wherein there is another similar protrusion in the region of the other corner which is adjacent to the said one corner.

4. The trowel of claim 1 wherein at least one protrusion is near a respective corner and preferably between the said one corner and the respective other corner.

5. The trowel of claim 1 wherein at least one protrusion is formed either by a pressing in the blade or by a stud or boss on the blade.

6. The trowel of claim 1 wherein at least one protrusion is smoothly curved from its base at or adjacent to the blade to its tip or free end distal from the main face of the blade.

7. The trowel of claim 1 wherein at least one protrusion is substantially circular in cross-sections parallel to the surface of the blade.

8. The trowel of claim 1 wherein at least one protrusion extends away from the blade a distance of up to 15 mm.

9. The trowel of claim 1 wherein the distance between at least one protrusion and the immediately adjacent corner of the blade is from 8 to 12 mm.

10. The trowel of claim 1 wherein the distance between the free end of at least one protrusion and the distal or remote face of the blade is either substantially 10 mm or substantially 6.35 mm (0.25 inch).

11. The trowel of claim 1 wherein the blade has a length in the range of about 20 to 30 cm and/or a width in the range of about 70 to 110 mm.

12. The trowel of claim 1 wherein the blade has a thickness of about 1.0 to about 3.0 mm.

13. The trowel of claim 1 also comprising a handle.

14. A trowel comprising a substantially flat quadrilateral blade with two opposing faces and having four corners and a handle at one corner, the blade having at least one protrusion on one face of the blade at, or in the region of, another corner of the blade.

15. The trowel of claim 14 wherein the said another corner is adjacent to the said one corner.

16. The trowel of claim 14 wherein there is another similar protrusion in the region of the other corner which is adjacent to the said one corner.

17. The trowel of claim 14 wherein at least one protrusion is near a respective corner and preferably between the said one corner and the respective other corner.

18. The trowel of claim 14 wherein at least one protrusion is formed either by a pressing in the blade or by a stud or boss on the blade.

19. The trowel of claim 14 wherein at least one protrusion is smoothly curved from its base at or adjacent to the blade to its tip or free end distal from the main face of the blade.

20. The trowel of claim 14 wherein at least one protrusion is substantially circular in cross-sections parallel to the surface of the blade.
